(19) United States
(12) Patent Application Publication
(10) Pub. No.: US 2025/0193916 A1
(43) Pub. Date: Jun. 12, 2025

(54) REFERENCE SIGNAL MEASUREMENT AND REPORTING

(71) Applicant: QUALCOMM Incorporated, San Diego, CA (US)

(72) Inventors: Qiaoyu Li, Beijing (CN); Hamed Pezeshki, San Diego, CA (US); Mahmoud Taherzadeh Boroujeni, San Diego, CA (US); Tao Luo, San Diego, CA (US)

(21) Appl. No.: 18/844,790

(22) PCT Filed: May 11, 2022
(86) PCT No.: PCT/CN2022/092206

§ 371 Date: Sep. 6, 2024

(51) Int. Cl. H04W 72/542; H04B 7/08; H04L 5/00

(52) U.S. Cl. CPC H04W 72/542; H04L 5/0048; H04L 5/0057; H04B 7/088

(57) ABSTRACT

Techniques related to wireless channel measurement and reporting are disclosed. Some aspects of the disclosure relate to devices and methods for communicating a channel state information (CSI) report configuration message configuring a CSI reference signal (CSI-RS) resource set with a parameter repetition set to on. One or more CSI-RS resources of the CSI-RS resource set are measured utilizing a plurality of spatial receiver (Rx) filters, the plurality of spatial Rx filters being either ordered by a radio access network (RAN) or reported by a user equipment (UE). A CSI report is then communicated according to the CSI report configuration message, the CSI report including signal quality measurement information based on the measuring of the one or more CSI-RS resources. Other aspects, embodiments, and features are also claimed and described.

### TECHNICAL FIELD

The technology discussed below relates generally to wireless communication systems, and more particularly, to reference signal measurement and reporting in connection with beamforming. Certain aspects may relate to techniques for enabling and providing communication devices configured to recognize the signature of a signal blockage in the moments before it occurs.

### INTRODUCTION

Many modern wireless communication networks employ millimeter-wave (mmW) technology, sometimes referred to as the extremely high frequency (EHF) band. Because these waveforms can suffer from high atmospheric attenuation and do not penetrate walls or obstacles very well, wireless communication networks typically employ highly directional beamforming for these wavelengths. However, these directed beams can be blocked by obstacles that move across the channel, such as motor vehicles that move in the line-of-sight between a transmitter and receiver.

Recent studies have shown that with certain types of signal blockage, there may be a recognizable signature a short time before the blockage event occurs. That is, by performing suitable channel measurements between a transmitter and receiver, a forthcoming blockage event may be anticipated and a beam management procedure may be capable of compensating for the blockage as it happens in real-time.

### BRIEF SUMMARY OF SOME EXAMPLES

The following presents a simplified summary of one or more aspects of the present disclosure, to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later. While some examples may be discussed as including certain aspects or features, all discussed examples may include any of the discussed features. And unless expressly described, no one aspect or feature is essential to achieve technical effects or solutions discussed herein.

In one example a user equipment (UE) and a method of wireless communication operable at a user equipment (UE) is disclosed. The UE receives a channel state information (CSI) report configuration message that configures a CSI reference signal (CSI-RS) resource set with a parameter repetition set to on. The UE further measures one or more CSI-RS resources of the CSI-RS resource set utilizing a plurality of spatial receiver (Rx) filters, the plurality of spatial Rx filters being either ordered by a radio access network (RAN) or reported by the UE. The UE further transmits a CSI report according to the CSI report configuration message, the CSI report including signal quality measurement information based on the measuring of the one or more CSI-RS resources.

In another example a radio access network (RAN) node and a method of wireless communication operable at a RAN node is disclosed. The RAN node transmits a CSI report configuration message configuring a CSI-RS resource set with a parameter repetition set to on. The RAN node further transmits a set of TCI-state identifiers associated with the CSI-RS resource set, for identifying a plurality of spatial Rx filters for receiving one or more CSI-RS resources of the CSI-RS resource set. The RAN node further transmits the one or more CSI-RS resources of the CSI-RS resource set and receives a CSI report according to the CSI report configuration message, the CSI report including signal quality measurement information based on a measurement of the one or more CSI-RS resources.

In another example a RAN node and a method of wireless communication operable at a RAN node is disclosed. The RAN node transmits a CSI report configuration message configuring a CSI-RS resource set with a parameter repetition set to on. The RAN node further transmits one or more CSI-RS resources of the CSI-RS resource set. The RAN node further receives a CSI report according to the CSI report configuration message, the CSI report including signal quality measurement information based on a measurement of the one or more CSI-RS resources. The RAN node further receives a selected TCI-states report including a set of TCI-state identifiers associated with the CSI-RS resource set, for identifying a plurality of spatial Rx filters for receiving the one or more CSI-RS resources of the CSI-RS resource set.

These and other aspects of the technology discussed herein will become more fully understood upon a review of the detailed description, which follows. Other aspects and features will become apparent to those of ordinary skill in the art, upon reviewing the following description of specific examples in conjunction with the accompanying figures. While the following description may discuss various advantages and features relative to certain examples, implementations, and figures, all examples can include one or more of the advantageous features discussed herein. In other words, while this description may discuss one or more examples as having certain advantageous features, one or more of such features may also be used in accordance with the other various examples discussed herein. In similar fashion, while this description may discuss certain examples as devices, systems, or methods, it should be understood that such examples of the teachings of the disclosure can be implemented in various devices, systems, and methods.

### BRIEF DESCRIPTION OF THE DRAWINGS

FIG. 1 is a schematic illustration of a wireless communication system according to some aspects of this disclosure.

FIG. 2 is a conceptual illustration of an example of a radio access network according to some aspects of this disclosure.

FIG. 3 is a schematic illustration of an example of a disaggregated base station architecture according to some aspects of this disclosure.

FIG. 4 is a schematic illustration of a user plane protocol stack and a control plane protocol stack in accordance with some aspects of this disclosure.

FIG. 5 is a schematic illustration of an organization of wireless resources in an air interface utilizing orthogonal frequency divisional multiplexing (OFDM) according to some aspects of this disclosure.

FIG. 6 is a block diagram illustrating a wireless communication system supporting multiple-input multiple-output (MIMO) communication according to some aspects of this disclosure.

FIG. 7 is a schematic illustration of a receiver (Rx) beam sweeping procedure in accordance with some aspects of this disclosure.

FIG. 8 is a call flow diagram illustrating an exemplary process for reporting signal quality according to some aspects of this disclosure.

FIG. 9 is a block diagram conceptually illustrating an example of a hardware implementation for a network node (gNB) according to some aspects of this disclosure.

FIG. 10 is a block diagram conceptually illustrating an example of a hardware implementation for a user equipment (UE) according to some aspects of this disclosure.

FIG. 11 is a flow chart illustrating an example of a process for reporting reference signal qualities according to some aspects of this disclosure.

FIG. 12 is a flow chart illustrating an example of a process for utilizing reference signal quality reporting according to some aspects of this disclosure.

### DETAILED DESCRIPTION

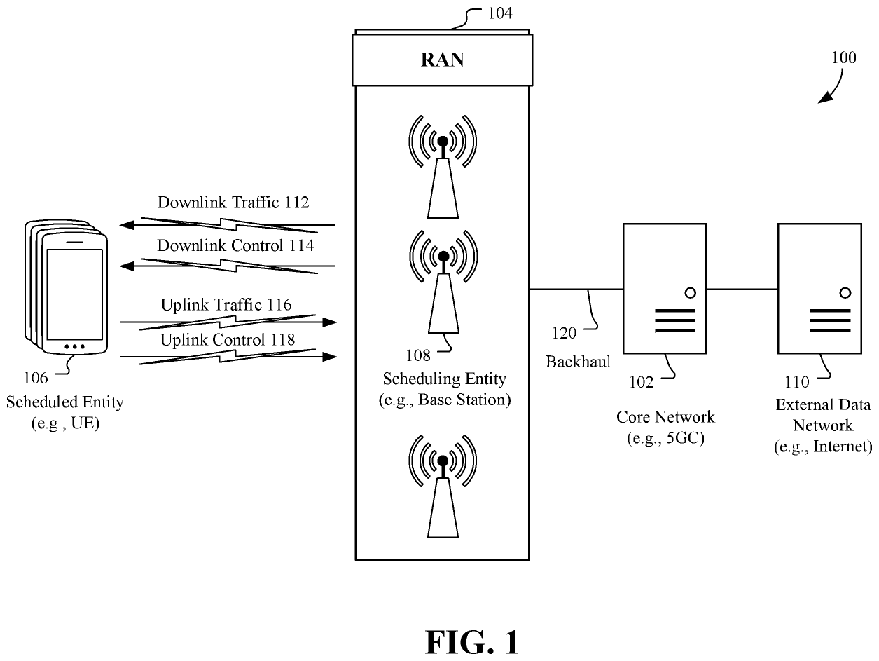

The disclosure that follows presents various concepts that may be implemented across a broad variety of telecommunication systems, network architectures, and communication standards. Referring now to FIG. 1, as an illustrative example without limitation, this schematic illustration shows various aspects of the present disclosure with reference to a wireless communication system 100. The wireless communication system 100 includes several interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G or 5G NR. In some examples, the RAN 104 may operate under a hybrid of 5G NR and Evolved Universal Terrestrial Radio Access Network (eUTRAN) standards, often referred to as Long-Term Evolution (LTE). 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, those skilled in the art may variously refer to a “base station” as a base transceiver station (BTS), a radio base station, a radio transceiver, a transceiver function, a basic service set (BSS), an extended service set (ESS), an access point (AP), a Node B (NB), an evolved Node B (eNB), a gNode B (gNB), a 5G NB, a transmit receive point (TRP), or some other suitable terminology.

The radio access network (RAN) 104 supports wireless communication for multiple mobile apparatuses. Those skilled in the art may refer to a mobile apparatus as a UE, as in 3GPP specifications, but may also refer to a UE as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides access to network services. A UE may take on many forms and can include a range of devices.

Within the present document, a “mobile” apparatus (aka a UE) need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; and agricultural equipment; etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data. A mobile apparatus may additionally include two or more disaggregated devices in communication with one another, including, for example, a wearable device, a haptic sensor, a limb movement sensor, an eye movement sensor, etc., paired with a smartphone. In various examples, such disaggregated devices may communicate directly with one another over any suitable communication channel or interface, or may indirectly communicate with one another over a network (e.g., a local area network or LAN).

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., network node 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a network node 108) allocates resources for communication among some or all devices and equipment within its service area or cell. Within the present disclosure, as discussed further below, a scheduling entity may be responsible for scheduling, assigning, reconfiguring, and releasing resources for one or more scheduled entities. That is, for scheduled communication, UEs 106, which may be scheduled entities, may utilize resources allocated by a scheduling entity 108.

Base stations are not the only entities that may function as scheduling entities. That is, in some examples, a UE or network node may function as a scheduling entity, scheduling resources for one or more scheduled entities (e.g., one or more UEs).

As illustrated in FIG. 1, a network node 108 may broadcast downlink traffic 112 to one or more UEs 106. Broadly, the network node 108 is a node or device responsible for scheduling traffic in a wireless communication network, including downlink traffic 112 and, in some examples, uplink traffic 116 from one or more UEs 106 to the network node 108. On the other hand, the UE 106 is a node or device that receives downlink control information 114, including but not limited to scheduling information (e.g., a grant), synchronization or timing information, or other control information from another entity in the wireless communication network such as the network node 108.

In general, network nodes 108 may include a backhaul interface for communication with a backhaul portion 120 of the wireless communication system. The backhaul 120 may provide a link between a network node 108 and the core network 102. Further, in some examples, a backhaul network may provide interconnection between the respective network nodes 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

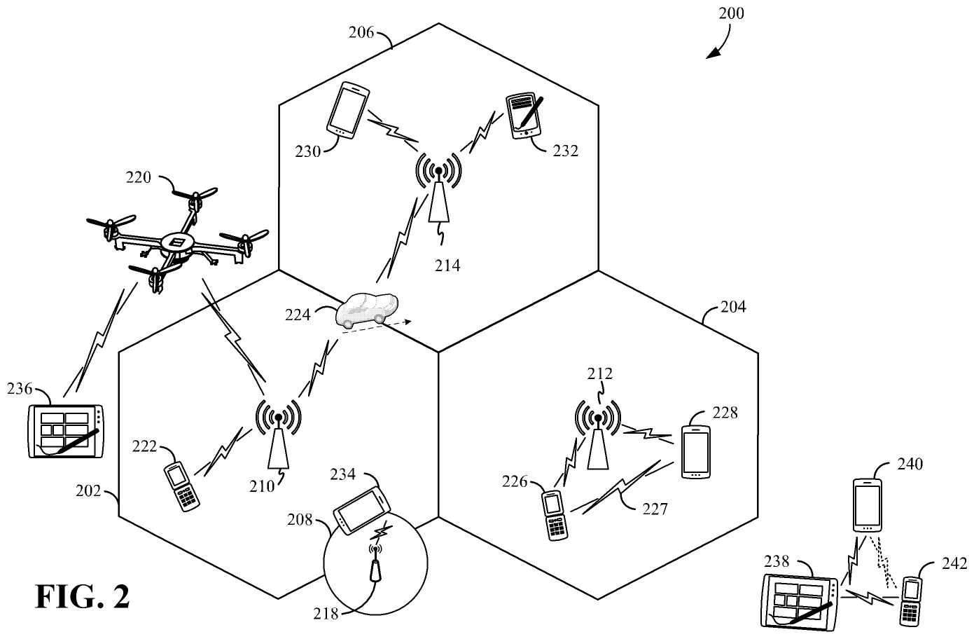

FIG. 2 provides a schematic illustration of a RAN 200, by way of example and without limitation. In some examples, the RAN 200 may be the same as the RAN 104 described above and illustrated in FIG. 1. The geographic area covered by the RAN 200 may be divided into cellular regions (cells) that a user equipment (UE) can uniquely identify based on an identification broadcasted from one access point, base station, or network node. FIG. 2 illustrates macrocells 202, 204, and 206, and a small cell 208.

FIG. 2 shows two three network nodes 210, and 212, and 214 in cells 202, 204, and 206. In the illustrated example, the cells 202, 204, and 206 may be referred to as macrocells, as the network nodes 210, 212, and 214 support cells having a large size. Further, a network node 218 is shown in the small cell 208 (e.g., a microcell, picocell, femtocell, home base station, home Node B, home eNode B, etc.) which may overlap with one or more macrocells. In this example, the cell 208 may be referred to as a small cell, as the network node 218 supports a cell having a relatively small size. Cell sizing can be done according to system design as well as component constraints.

The RAN 200 may include any number of wireless network nodes and cells. Further, a RAN may include a relay node to extend the size or coverage area of a given cell. The network nodes 210, 212, 214, 218 provide wireless access points to a core network for any number of mobile apparatuses. In some examples, the network nodes 210, 212, 214, and/or 218 may be the same as the base station/scheduling entity 108 described above and illustrated in FIG. 1.

FIG. 2 further includes a quadcopter or drone 220, which may be configured to function as a network node. That is, in some examples, a cell may not necessarily be stationary, and the geographic area of the cell may move according to the location of a mobile network node such as the quadcopter 220.

Within the RAN 200, each network node 210, 212, 214, 218, and 220 may be configured to provide an access point to a core network 102 (see FIG. 1) for all the UEs in the respective cells. For example, UEs 222 and 224 may be in communication with network node 210; UEs 226 and 228 may be in communication with network node 212; UEs 230 and 232 may be in communication with network node 214; UE 234 may be in communication with network node 218; and UE 236 may be in communication with mobile network node 220. In some examples, the UEs 222, 224, 226, 228, 230, 232, 234, 236, 238, 240, and/or 242 may be the same as the UE/scheduled entity 106 described above and illustrated in FIG. 1.

In some examples, a mobile network node (e.g., quadcopter 220) may be configured to function as a UE. For example, the quadcopter 220 may operate within cell 202 by communicating with network node 210.

In a further aspect of the RAN 200, sidelink signals may be used between UEs without necessarily relying on scheduling or control information from a network node (e.g., a scheduling entity). For example, two or more UEs (e.g., UEs 226 and 228) may communicate with each other using peer to peer (P2P) or sidelink signals 227 without relaying that communication through a network node. In a further example, UE 238 is illustrated communicating with UEs 240 and 242. Here, the UE 238 may function as a scheduling entity or a primary sidelink device, and UEs 240 and 242 may function as a scheduled entity or a non-primary (e.g., secondary) sidelink device. In still another example, a UE may function as a scheduling entity in a device-to-device (D2D), peer-to-peer (P2P), or vehicle-to-vehicle (V2V) network, and/or in a mesh network. In a mesh network example, UEs 240 and 242 may optionally communicate directly with one another in addition to communicating with the scheduling entity 238. Thus, in a wireless communication system with scheduled access to time-frequency resources and having a cellular configuration, a P2P configuration, or a mesh configuration, a scheduling entity and one or more scheduled entities may communicate utilizing the scheduled resources.

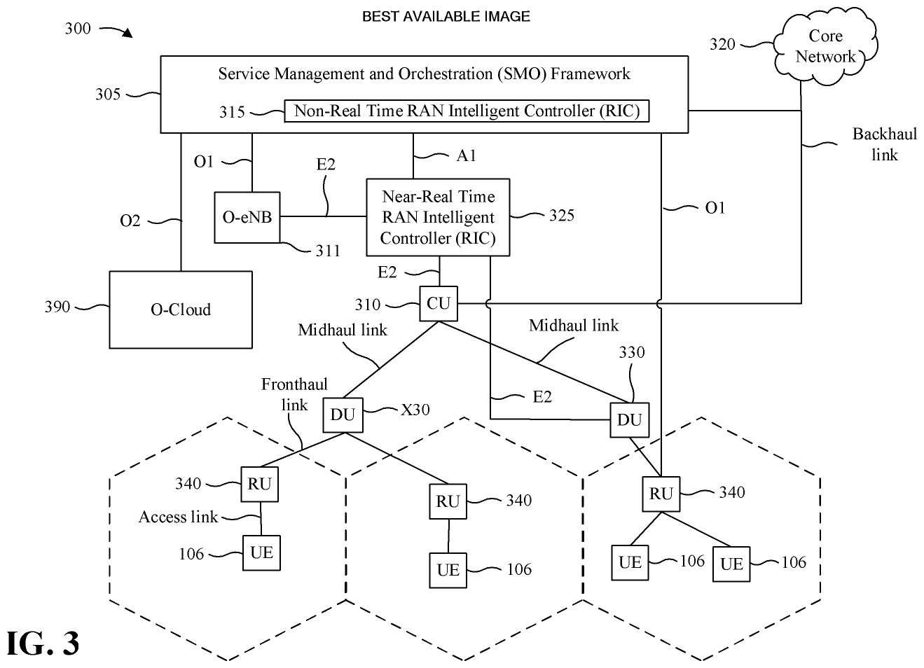

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 106 via one or more radio frequency (RF) access links. In some implementations, the UE 106 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 106. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

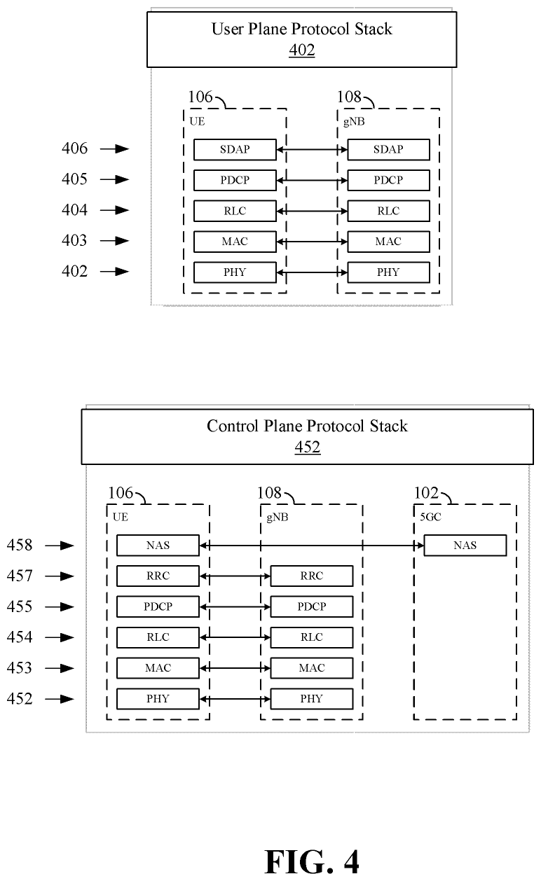

FIG. 4 is a schematic illustration of a user plane protocol stack 402 and a control plane protocol stack 452 in accordance with some aspects of this disclosure. In a wireless telecommunication system, the communication protocol architecture may take on various forms depending on the application. For example, in a 3GPP NR system, the signaling protocol stack is divided into Non-Access Stratum (NAS, 458) and Access Stratum (AS, 402-406 and 452-457) layers and protocols. The NAS protocol 458 provides upper layers, for signaling between a UE 106 and a core network 102 (referring to FIG. 1). The AS protocol 402-406 and 452-457 provides lower layers, for signaling between the RAN 104 (e.g., a gNB or other network node 108) and the UE 106.

Turning to FIG. 4, a radio protocol architecture is illustrated with a user plane protocol stack 402 and a control plane protocol stack 452, showing their respective layers or sublayers. Radio bearers between a network node 108 and a UE 106 may be categorized as data radio bearers (DRB) for carrying user plane data, corresponding to the user plane protocol 402; and signaling radio bearers (SRB) for carrying control plane data, corresponding to the control plane protocol 452.

In the AS, both the user plane 402 and control plane 452 protocols include a physical layer (PHY) 402/452, a medium access control layer (MAC) 403/453, a radio link control layer (RLC) 404/454, and a packet data convergence protocol layer (PDCP) 405/455. PHY 402/452 is the lowest layer and implements various physical layer signal processing functions. The MAC layer 403/453 provides multiplexing between logical and transport channels and is responsible for various functions. For example, the MAC layer 403/453 is responsible for reporting scheduling information, priority handling and prioritization, and error correction through hybrid automatic repeat request (HARQ) operations. The RLC layer 404/454 provides functions such as sequence numbering, segmentation and reassembly of upper layer data packets, and duplicate packet detection. The PDCP layer 405/455 provides functions including header compression for upper layer data packets to reduce radio transmission overhead, security by ciphering the data packets, and integrity protection and verification.

In the user plane protocol stack 402, a service data adaptation protocol (SDAP) layer 406 provides services and functions for maintaining a desired quality of service (QoS). And in the control plane protocol stack 452, a radio resource control (RRC) layer 457 includes a number of functional entities for routing higher layer messages, handling broadcasting and paging functions, establishing and configuring radio bearers, NAS message transfer between NAS and UE, etc.

A NAS protocol layer 458 provides for a wide variety of control functions between the UE 106 and core network 102. These functions include, for example, registration management functionality, connection management functionality, and user plane connection activation and deactivation.

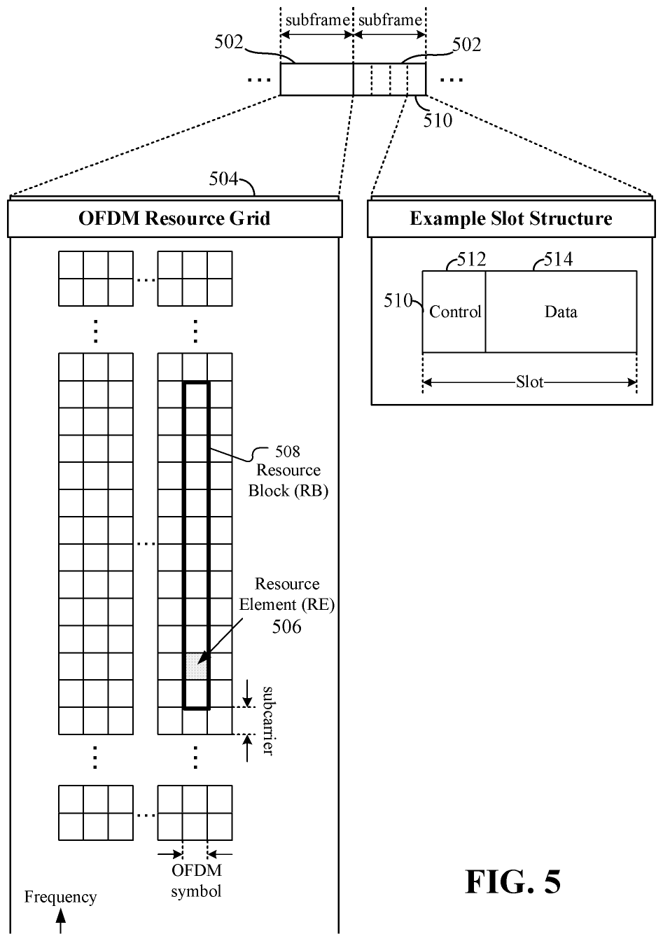

FIG. 5 schematically illustrates various aspects of the present disclosure with reference to an OFDM waveform. Those of ordinary skill in the art should understand that the various aspects of the present disclosure may be applied to a DFT-s-OFDMA waveform in substantially the same way as described herein below. That is, while some examples of the present disclosure may focus on an OFDM link for clarity, it should be understood that the same principles may be applied as well to DFT-s-OFDMA waveforms.

In some examples, a frame may refer to a predetermined duration of time (e.g., 10 ms) for wireless transmissions. And further, each frame may include a set of subframes (e.g., 10 subframes of 1 ms each). A given carrier may include one set of frames in the UL, and another set of frames in the DL. FIG. 5 illustrates an expanded view of an exemplary DL subframe 502, showing an OFDM resource grid 504. However, as those skilled in the art will readily appreciate, the PHY transmission structure for any application may vary from the example described here, depending on any number of factors. Here, time is in the horizontal direction with units of OFDM symbols; and frequency is in the vertical direction with units of subcarriers or tones.

The resource grid 504 may schematically represent time-frequency resources for a given antenna port. That is, in a multi-input multi-output (MIMO) implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid and may contain a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may span 12 subcarriers, a number independent of the numerology used. In some examples, depending on the numerology, an RB may include any suitable number of consecutive OFDM symbols in the time domain.

A given UE generally utilizes only a subset of the resource grid 504. An RB may be the smallest unit of resources that a scheduler can allocate to a UE. Thus, the more RBs scheduled for a UE, and the higher the modulation scheme chosen for the air interface, the higher the data rate for the UE.

In this illustration, RB 508 occupies less than the entire bandwidth of the subframe 502, with some subcarriers illustrated above and below the RB 508. In a given implementation, subframe 502 may have a bandwidth corresponding to any number of one or more RBs 508. Further, the RB 508 is shown occupying less than the entire duration of the subframe 502, although this is merely one possible example.

Each 1 ms subframe 502 may include one or multiple adjacent slots. In FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots having a shorter duration (e.g., one or two OFDM symbols). A network node may in some cases transmit these mini-slots occupying resources scheduled for ongoing slot transmissions for the same or for different UEs.

An expanded view of one of the slots 510 illustrates the slot 510 including a control region 512 and a data region 514. In general, the control region 512 may carry control channels (e.g., PDCCH), and the data region 514 may carry data channels (e.g., PDSCH or PUSCH). Of course, a slot may contain all DL, all UL, or at least one DL portion and at least one UL portion. The structure illustrated in FIG. 5 is merely exemplary in nature, and different slot structures may be utilized, and may include one or more of each of the control region(s) and data region(s).

Although not illustrated in FIG. 5, the various REs 506 within an RB 508 may carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In a DL transmission, the transmitting device (e.g., a network node 108) may allocate one or more REs 506 (e.g., within a control region 512) to carry one or more DL control channels. These DL control channels include DL control information 114 (DCI) that generally carries information originating from higher layers, such as a physical broadcast channel (PBCH), a physical downlink control channel (PDCCH), etc., to one or more UEs 106. In addition, the network node may allocate one or more DL REs to carry DL physical signals that generally do not carry information originating from higher layers. These DL physical signals may include a primary synchronization signal (PSS); a secondary synchronization signal (SSS); demodulation reference signals (DM-RS); phase-tracking reference signals (PT-RS); channel-state information reference signals (CSI-RS); etc.

A network node may transmit the synchronization signals PSS and SSS (collectively referred to as SS), and in some examples, the PBCH, in an SS block that includes 4 consecutive OFDM symbols. In the frequency domain, the SS block may extend over 240 contiguous subcarriers. Of course, the present disclosure is not limited to this specific SS block configuration. Other nonlimiting examples may utilize greater or fewer than two synchronization signals; may include one or more supplemental channels in addition to the PBCH; may omit a PBCH; and/or may utilize nonconsecutive symbols for an SS block, within the scope of the present disclosure.

The PDCCH may carry downlink control information (DCI) for one or more UEs in a cell. This can include, but is not limited to, power control commands, scheduling information, a grant, and/or an assignment of REs for DL and UL transmissions.

In an UL transmission, a transmitting device (e.g., a UE 106) may utilize one or more REs 506 to carry one or more UL control channels, such as a physical uplink control channel (PUCCH), a physical random access channel (PRACH), etc. These UL control channels include UL control information 118 (UCI) that generally carries information originating from higher layers. Further, UL REs may carry UL physical signals that generally do not carry information originating from higher layers, such as demodulation reference signals (DM-RS), phase-tracking reference signals (PT-RS), sounding reference signals (SRS), etc. In some examples, the control information 118 may include a scheduling request (SR), i.e., a request for the network node 108 to schedule uplink transmissions. Here, in response to the SR transmitted on the UL control channel 118 (e.g., a PUCCH), the network node 108 may transmit downlink control information (DCI) 114 that may schedule resources for uplink packet transmissions.

UL control information may also include hybrid automatic repeat request (HARQ) feedback such as an acknowledgment (ACK) or negative acknowledgment (NACK), channel state information (CSI), or any other suitable UL control information. HARQ is a technique well-known to those of ordinary skill in the art, wherein a receiving device can check the integrity of packet transmissions for accuracy, e.g., utilizing any suitable integrity checking mechanism, such as a checksum or a cyclic redundancy check (CRC). If the receiving device confirms the integrity of the transmission, it may transmit an ACK, whereas if not confirmed, it may transmit a NACK. In response to a NACK, the transmitting device may send a HARQ retransmission, which may implement chase combining, incremental redundancy, etc.

In addition to control information, one or more REs 506 (e.g., within the data region 514) may be allocated for user data or traffic data. Such traffic may be carried on one or more traffic channels, such as, for a DL transmission, a physical downlink shared channel (PDSCH); or for an UL transmission, a physical uplink shared channel (PUSCH).

The channels or carriers described above and illustrated in FIGS. 1 and 5 are not necessarily all the channels or carriers that may be utilized between a network node 108 and UE 106, and those of ordinary skill in the art will recognize that other channels or carriers may be utilized in addition to those illustrated, such as other traffic, control, and feedback channels.

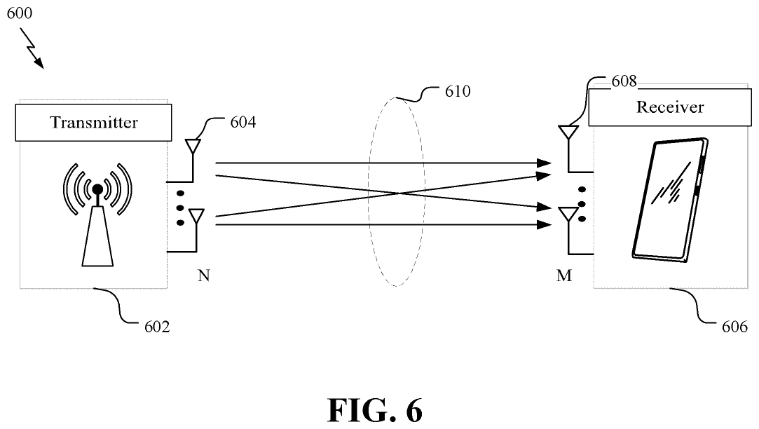

In some aspects of the disclosure, a network node and/or UE may be configured with multiple antennas for beamforming and/or multiple-input multiple-output (MIMO) technology. FIG. 6 illustrates an example of a wireless communication system 600 with multiple antennas, supporting beamforming and/or MIMO. The use of such multiple antenna technology enables the wireless communication system to exploit the spatial domain to support spatial multiplexing, beamforming, and transmit diversity.

Beamforming generally refers to directional signal transmission or reception. For a beamformed transmission, a transmitting device may apply a suitable spatial filter to precode, or control the amplitude and phase of each antenna in an array of antennas to create a desired (e.g., directional) pattern of constructive and destructive interference in the wavefront. Similarly, a receiving device may apply a suitable spatial filter for directional beam receiving.

In some examples, a transmitter 602 may exploit a transmission configuration indicator (TCI)-state to indicate which beam the transmitter 602 or the receiver 606 is using for a transmission. Specifically, a transmitter 602 may indicate that a transmission is allocated to resources in a certain PDSCH/PUSCH that uses the same transmission beam (i.e., the same Tx spatial filter) as a configured reference signal (e.g., CSI-RS or SS block) based on a TCI-state. Thus, the receiver 606 may know that a transmission beam for a transmission shares similar channel characteristics to a reference signal based on a TCI-state. For example, a transmitter 602 may transmit a list of TCI-states to a receiver 606 via an RRC message to decode PDSCH/PUSCH according to a detected PDCCH with DCI. A TCI-state may contain parameters for configuring a quasi co-location (QCL) relationship between a configured downlink reference signal (e.g., CSI-RS or SS block) and a certain PDSCH/PUSCH. That is, properties of the channel on which the PDSCH/PUSCH is transmitted can be inferred from the channel over which the downlink reference signal is transmitted. Then, the transmitter 602 may activate or deactivate TCI-states via a control message (e.g., a MAC control element, or MAC-CE message). If a control message deactivates a TCI-state, a scheduling grant (e.g., a DCI message) may not map the TCI-state to a codepoint in the scheduling grant. If a control message activates a TCI-state, a scheduling grant may map the TCI-state to a TCI-state indicator of a TCI codepoint in the scheduling grant. Thus, if a TCI-state is activated, a TCI-state indicator of a TCI codepoint in a scheduling grant may map the corresponding TCI-state to a resource assignment for a corresponding communication (e.g., a TB or a set of TBs).

The transmitter 602 determines the precoding of the transmitted data stream or streams based, e.g., on known channel state information of the channel on which the transmitter 602 transmits the data stream(s). For example, the transmitter 602 may transmit one or more suitable reference signals (e.g., a channel state information reference signal, or CSI-RS) that the receiver 606 may measure. The receiver 606 may then report various parameters back to the transmitter 602 in a CSI report. This CSI report may include channel quality information (CQI) indicating the current communication channel quality, and in some examples, a requested transport block size (TBS) for future transmissions to the receiver. In some examples, the receiver 606 may further report a precoding matrix indicator (PMI) to the transmitter 602. This PMI generally reports the receiver's 606 preferred precoding matrix for the transmitter 602 to use, and may be indexed to a predefined codebook. The transmitter 602 may then utilize this CQI/PMI to determine a suitable precoding matrix for transmissions to the receiver 606.

The use of highly directional beams in beamforming raises the need for alignment of the transmit (Tx) beams and receive (Rx) beams. A wireless network may dynamically achieve this alignment using beam management. Beam management describes a set of procedures that enable a wireless network to perform beam switching based on measurements of reference signals and measurement reporting. Beam management may employ a function called beam sweeping. Beam sweeping refers to covering a spatial area with a set of beams transmitted and/or received according to pre-specified intervals and directions. Here, the different beams are provided utilizing suitable spatial filters. Reference signals transmitted on the respective beams are measured and their quality characterized utilizing various parameters such as a reference signal received power (RSRP), a signal-to-interference-and-noise ratio (SINR), etc. The receiving device may then determine a suitable beam or beams based on the measurements. In some examples, a UE may further employ beam reporting whereby the UE transmits beam quality and/or beam selection information to the gNB based on the measurements. Based on these measurements and reports, a process of beam switching and beam failure recovery can be dynamically carried out.

From time to time, due to UE mobility, reorientation, and/or signal blockage, the radio link quality of the respective beams may vary. With a degradation in quality of a currently selected beam pair, beam management allows the UE and gNB to switch to another more suitable beam pair.

Recent studies have shown that with certain types of signal blockage, such as a motor vehicle moving across a signal path between a transmitter and receiver, there may be a recognizable signature a short time before the blockage event occurs. That is, by performing beam sweeping procedures a forthcoming blockage event may be anticipated and a beam management procedure may be capable of compensating for the blockage as it happens. Research is being performed on using artificial intelligence (AI) and machine learning (ML) to recognize such a pre-blockage signature and to compensate for an anticipated beam failure. According to various aspects this disclosure provides for beam reporting that may facilitate such blockage-anticipating procedures.

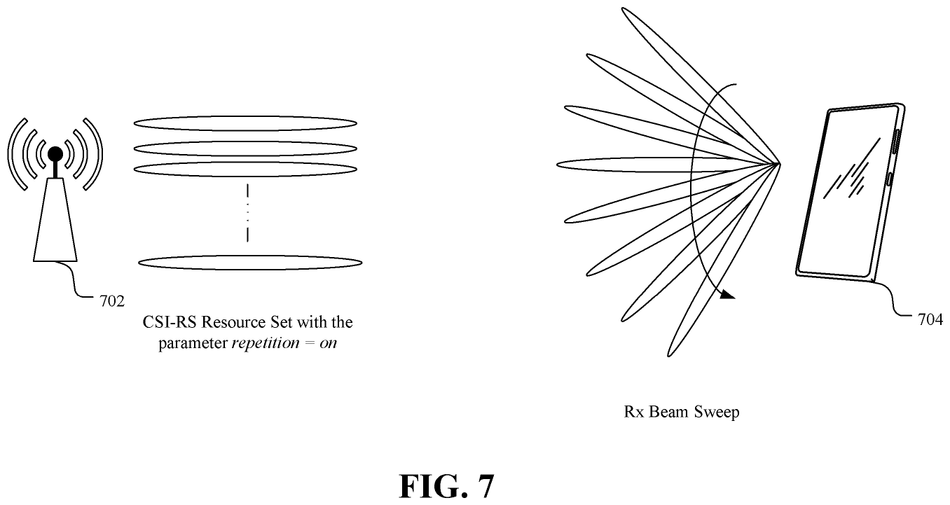

FIG. 7 illustrates an exemplary Rx beam sweeping procedure according to some aspects of this disclosure. As shown in the illustration, a UE 704 may sweep its Rx beams while a gNB 702 transmits a CSI-RS on repetitive beams over different time instances. This corresponds to a CSI-RS resource set having the parameter repetition=on. That is, the CSI-RS resources within the set are transmitted using the same Tx beam spatial filter. This allows the UE 704 to find the best spatial Rx filter (Rx beam) over those repetitive Tx beams.

An issue with this Rx beam sweeping procedure is that it is not well-supported in existing 3GPP specifications for 5G NR. That is, when a UE is configured with a CSI-RS resource set with the parameter repetition=on, while the UE can report the RSRP for the best beam, the UE does not report a CSI-RS resource indicator (CRI) for that beam. That is, there is no specification for per-beam reporting when sweeping Rx beams rather than Tx beams. Therefore, in some aspects the present disclosure provides a methodology for associating Rx beams with their reported signal quality from the UE 704 to the gNB 702 when the UE 704 is configured with a CSI-RS resource set with the parameter repetition=on.

For example, to accommodate the reporting of a beam quality for a set of one or more identified Rx beams during Rx beam sweeping, when the UE is configured with a CSI-RS resource set with the parameter repetition=on, the UE may be configured with certain settings for a CSI report: a selection of which Rx spatial filters to use during the Rx beam sweep, and a selection of which Rx spatial filters for which to report a signal quality (e.g., RSRP or SINR). In some aspects, the present disclosure provides for a gNB to order a set of Rx spatial filters for the UE to use to receive different CSI-RS resources within the CSI-RS resource set. In other aspects, the present disclosure provides for a UE to recommend to a gNB which Rx spatial filters the UE should use to receive different CSI-RS resources within the CSI-RS resource set. And in some aspects, the present disclosure provides that the report configured by a CSI report setting includes a signal quality (e.g., RSRPs and/or SINRs) associated with an identified set of Rx spatial filters used by the UE for receiving different CSI-RS resources.

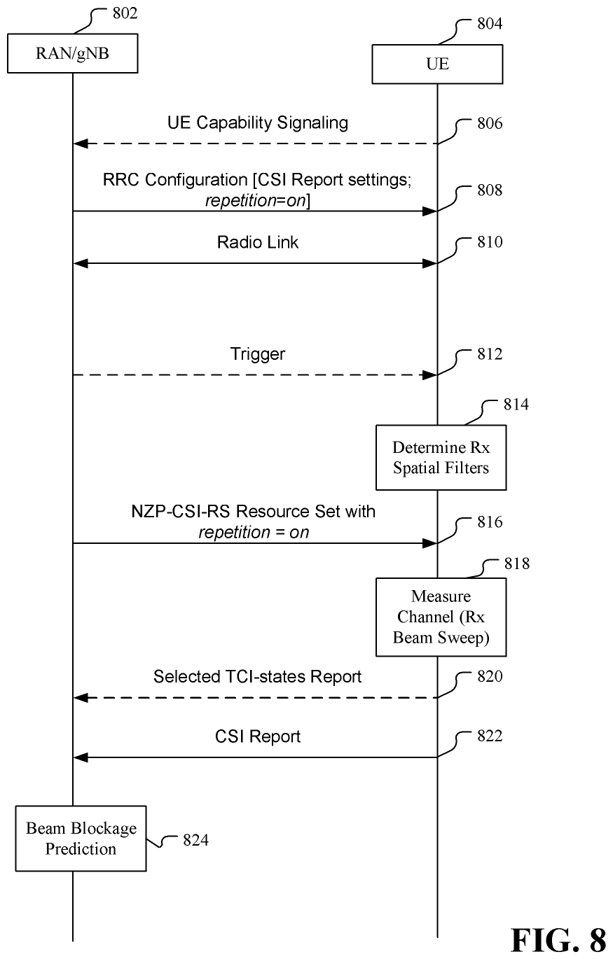

FIG. 8 is a call flow diagram illustrating an exemplary process for reporting signal quality with a CSI-RS resource set having the parameter repetition=on via different Rx spatial filters according to some aspects of this disclosure.

In some examples, a UE 804 may utilize UE capability information signaling 806 to inform the RAN 802 about certain capabilities of the UE 804. As discussed further below, in some examples, a UE may provide capability information signaling 806 related to signal quality reporting with a CSI-RS resource set having the parameter repetition=on. For example, as discussed above, the RAN might expect that when a CSI resource set is configured with the parameter repetition=on, that the UE would not report CRIs in association with signal quality measurements (e.g., RSRPs/SINRs). Thus, the UE 804 may report in UE capability signaling 806 that the UE 804 supports a feature of reporting signal quality measurement information (e.g., RSRPs or SINRs) in association with CSI-RS resources when the parameter repetition is set to on. Further, the UE 804 may provide the RAN 802 with the maximum number of signal qualities (e.g., RSRPs and/or SINRs) that the UE 804 has the capability to report in a CSI report.

At 808 the RAN 802 may provide the UE 804 with RRC signaling to configure CSI report settings. That is, for example at the establishment of a radio connection, or at any other suitable time, RRC signaling can set up a variety of communication protocols and settings for a UE 804 to employ for communication with the RAN 802. Included in this RRC signaling can be a set of CSI report settings, for employment during an Rx beam sweep when the UE 804 is measuring a CSI-RS resource set with the parameter repetition=on. Once the RRC configuration 808 is established, the UE 804 may establish and utilize a radio link 810 with the RAN 802.

Depending on the configuration of a given CSI-RS resource, a measurement of the corresponding CSI-RS resource set may be triggered or activated utilizing a suitable trigger message 812. For example, an aperiodic CSI-RS resource may be dynamically triggered utilizing a suitable DCI, and a semi-periodic CSI-RS resource may be triggered or activated utilizing a MAC-CE. On the other hand, a periodic CSI-RS resource may be periodically transmitted without necessarily utilizing a trigger 812, and its parameters may be configured via RRC signaling 808.

At block 814, the UE 804 may select a set of Rx spatial filters to employ for an Rx beam sweep for measuring a CSI-RS resource set 816 configured with the parameter repetition=on. As described in further detail below, the UE 804 may either utilize a gNB-ordered set of Rx spatial filters, or the UE 804 may recommend to the RAN 802 a set of Rx spatial filters for receiving the CSI-RSs 816.

For example, according to some aspects the RAN/gNB 802 may configure or indicate to the UE 804 a set of TCI-states associated with different CSI-RS resources. That is, in existing specifications for 3GPP 5G NR, protocols are established for a gNB to order a UE to receive a certain Tx beam from a certain direction by indicating to the UE a set of TCI-states associated with those Tx beams. According to an aspect of the present disclosure, the same or similar signaling can be employed to indicate a set of Rx beam directions. That is, the RAN 802 may order the UE 804 to receive an indicated CSI-RS resource associated with an Rx spatial filter by indicating a set of TCI-states to the UE 804. This indicated set of TCI-states can be associated with different CSI-RS resources corresponding to selected Rx spatial filters for the UE 804 to use.

In some examples, the RAN 802 may provide the indicated set of TCI-states utilizing RRC signaling 808. For example, for a periodic CSI-RS resource, the RAN 802 may utilize RRC signaling 808 to configure the UE 804 for a CSI report corresponding to a periodic CSI-RS resource set with repetition=on. In this RRC configuration 808 the RAN 802 may provide a set of TCI-states associated with a set of CSI-RS resources.

In further examples, the RAN 802 may provide the indicated set of TCI-states utilizing a suitable trigger message 812. For example, for a semi-periodic CSI-RS resource, the RAN 802 may transmit a MAC-CE for activating the CSI-RS resource. And in another example, for an aperiodic CSI-RS resource, the RAN 802 may transmit a DCI for dynamically triggering the CSI-RS resource. In these examples, the trigger message 812 (e.g., a DCI or MAC-CE) may provide a set of TCI-states associated with a set of CSI-RS resources.

In such examples wherein the RAN/gNB 802 indicates to the UE 804 a set of Rx spatial filters, the UE 804 may expect that the existing information element (IE) qcl-InfoPeriodicCSI-RS associated with different CSI-RS resources should correspond to different TCI-states.

In another example, according to further aspects, the UE 804 may have the capability to select a set of preferred spatial Rx filters from among a plurality of candidate spatial Rx filters. That is, in some examples, a UE 804 may report a set of TCI-states as the set of Rx spatial filters that it would use for receiving the respective CSI-RS resources.

For example, the RAN/gNB 802 may preconfigure the UE 804 with a set of TCI-states associated with the CSI report/resource settings provided at RRC configuration 808. In this case, the UE 804 may select among those preconfigured TCI-states a set of TCI-states corresponding to its selected Rx spatial filters. The UE 804 may in some examples select a suitable set of TCI-states based on a given semi-periodic or aperiodic trigger message 812. In other examples, the UE 804 may be enabled to report any set of TCI-states that it prefers from among the preconfigured set of TCI-states.

In another example, the UE 804 may utilize static or semi-static signaling to report a selected set of TCI-states. For example, the UE 804 may transmit a selected TCI-states report 820, e.g., as an RRC message or as a MAC-CE. In this case, the set of Rx spatial filters utilized for an Rx beam sweep may be fixed across multiple CSI reports that carry the beam measurements (e.g., the RSRPs and/or SINRs).

In still another example, the UE 804 may utilize dynamic signaling to report a selected set of TCI states. For example, the UE 804 may transmit an indication of its selected TCI-states together with the CSI report 822 that carries the beam measurements (e.g., the RSRPs and/or SINRs).

Thus, as described above, in some examples, a RAN node or gNB 802 may order, configure, or indicate to the UE 804 a set of TCI-states associated with different CSI-RS resources corresponding to Rx beams (e.g., Rx spatial filters) to measure during an Rx beam sweep associated with a CSI-RS resource set with the parameter repetition=on. And in other examples, a UE may select a set of TCI-states associated with different CSI-RS resources corresponding to Rx beams to measure during an Rx beam sweep associated with a CSI-RS resource set with the parameter repetition=on. Similarly, in some examples, a RAN node or gNB 802 may order or indicate to the UE 804 which signal qualities (e.g., RSRPs and/or SINRs) the UE 804 should report in a CSI report 822. And in other examples, a UE 804 may determine which signal qualities the UE 804 should report in a CSI report 822.

That is, some aspects of this disclosure provide for a RAN node or gNB 802 to indicate to a UE 804 a set of one or more CSI-RS resource IDs (CSIs) that are associated with the configured CSI-RS resource set. Here, the UE 804 may treat these CRIs as an indication of which RSRPs or SINRs the CSI report 822 should carry. The RAN node or gNB 802 may indicate the set of CRIs dynamically (e.g., via DCI, MAC-CE, or any other suitable message) or may preconfigure the UE with the set of CRIs (e.g., via RRC signaling 808 during CSI report configuration).

In further aspects, this disclosure provides for a RAN node or gNB 802 to indicate to a UE 804 a set of one or more TCI-state IDs that are associated with the configured CSI-RS resource set. That is, recall that above it was described that the RAN node or gNB 802 may indicate to the UE which Rx spatial filters to utilize by sending static, semi-static, or dynamic signaling to indicate a set of TCI-state IDs that are associated with a set of Rx spatial filters. As an extension of this concept, those indicated TCI-state IDs may be associated with a portion of the CSI-RS resource set. Thus, the UE can also treat these indicated TCI-state IDs as an indication of which RSRPs or SINRs the CSI report 822 should carry.

In some examples, where the UE reports the RSRPs or SINRs for every CSI-RS resource within the configured CSI-RS resource set, the gNB 802 may not need to indicate any particular CSI-RS/TCI-state IDs as gNB order commands. That is, when the UE reports for every spatial Rx filter, the gNB 802 may omit any signaling indicating a subset of Rx spatial filters to report.

In still further aspects, when the gNB 802 orders which RSRPs or SINRs for the UE 804 to report, the UE may utilize the following three-step procedure to quantize the RSRPs or SINRs for transmission with the CSI report 822. First, the UE 804 reports the CRI or TCI-state ID (depending on which is used to indicate which RSRPs/SINRs to report) that is associated with the beam with the strongest measured RSRP/SINR among the CSI-RS resources ordered by the gNB 802. Second, the UE 804 may report the absolute value of that strongest measured RSRP/SINR. And third, the UE 804 may report differential values of other RSRPs/SINRs, relative to the strongest one, e.g., in ascending or descending order of associated CRIs or TCI-state IDs.

In other aspects, this disclosure provides that a UE 804 may determine which signal qualities the UE 804 should report in a CSI report 822. Here, the UE 804 may report both the CRIs or TCI-state IDs and their corresponding RSRPs/SINRs differentially, referring to the strongest RSRP/SINR. However, to reduce overhead signaling, according to a further aspect, the gNB 802 may preconfigure sub-groups or sub-sets of CRIs or TCI-state IDs for a configured CSI-RS resource set. For example, assume that a CSI-RS resource set includes M CRIs or TCI-state IDs. At RRC configuration 808, the gNB 802 may configure a number N of sub-groups or sub-sets of CRIs or TCI-state IDs, where each of the N sub-groups or sub-sets includes a number Sn≤M CRIs or TCI-state IDs. That is, each of the N sub-groups or sub-sets may include any suitable number of CRIs or TCI-state IDs, up to M. Different sub-groups or sub-sets need not necessarily include the same number of CRIs or TCI-state IDs. As a detailed example for illustrative purposes, at RRC configuration 808, the gNB 802 may configure a CSI-RS resource set with eight (8) CRIs indexed 1-8. Further, the gNB 802 may configure three (3) sub-groups or sub-sets of CRIs, respectively including indices A={1, 4, 7}, B={2, 5, 8}, and C={3, 6}. With such configuration, the UE can report an option ID (e.g., A, B, or C) to identify which sub-set or sub-group it selected rather than explicitly reporting the CRIs or TCI-state IDs of the RSRPs/SINRs being reported. Here, the UE may still report the CRI/TCI-state ID of the strongest RSRP/SINR within the subgrouping. However, the remaining CRIs/TCI-state IDs need not be reported, as their RSRPs/SINRs can be reported in ascending/descending order within the subgrouping.

In the CSI report 822, when the UE 804 reports RSRPs/SINRs, the reports can be separated from conventional signaling for the parameters cri-RSRP or cri-SINR. That is, while the parameters cri-RSRP and cri-SINR are employed in existing 3GPP specifications for 5G NR, the CSI report 822 described above in the present disclosure may utilize different parameters. For example, the UE may report RSRPs/SINRs utilizing new parameters RxSweep-cri-RSRP or RxSweep-cri-SINR. In this case, if such new parameters are utilized for UE reporting of RSRPs/SINRs in a CSI report 822, the UE may always expect or assume that the CSI-RS resource set associated with the CSI report setting should be configured with the parameter repetition on. And, if the gNB orders or indicates the set of Rx spatial filters for the UE to employ, as in some of the examples described above, the UE may always expect or assume that the existing IEs qcl-InfoPeriodicCSI-RS associated with different CSI-RS resources should correspond to different TCI-states.

In a further aspect of this disclosure, the total number of reported SINRs/RSRPs in the CSI report 822 and associated with the features introduced above may be preconfigured by the gNB 802 in the CSI report setting 808. For example, the CSI report settings 808 may include a value for the parameter nrofReportedRS indicating the number of RSRPs/SINRs for the UE 804 to report in the CSI report 822. As mentioned above, in some examples, a UE 804 may employ UE capability signaling 806 to inform the gNB 802 of its maximum supported value of such total number of RSRPs/SINRs.

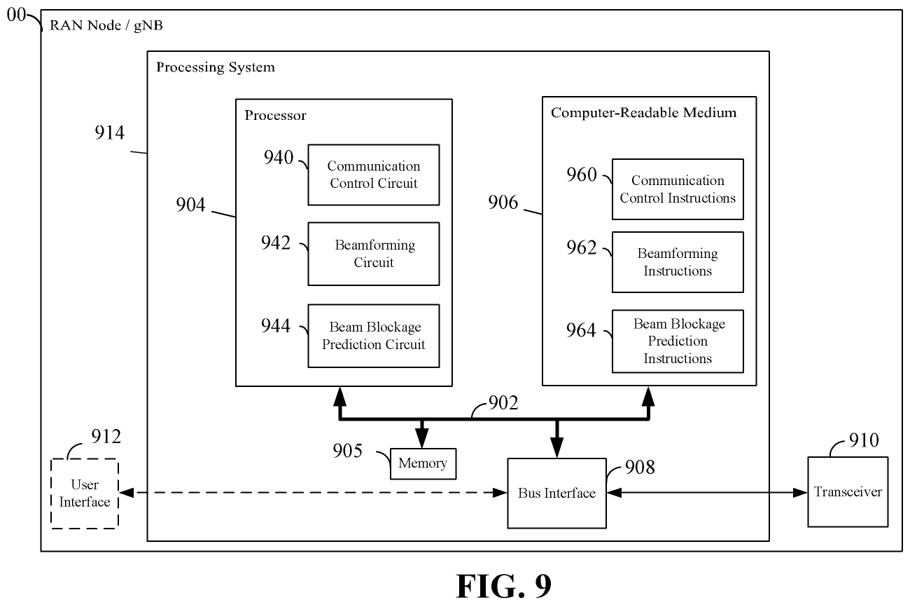

FIG. 9 is a block diagram illustrating an example of a hardware implementation for a gNB 900 employing a processing system 914. For example, the gNB 900 may be gNB or base station as illustrated in any one or more of FIGS. 1, 2, 3, 5, 7, and/or 8.

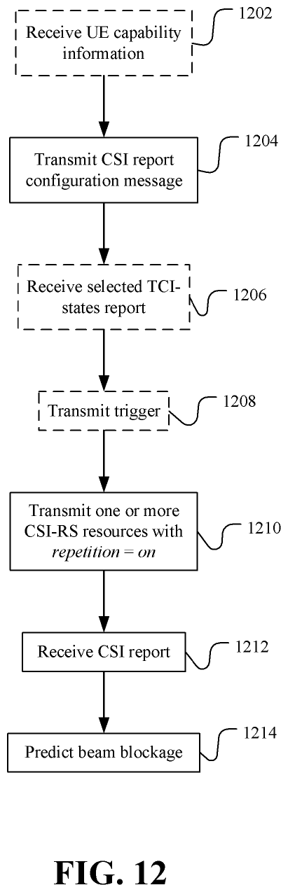

The gNB 900 may include a processing system 914 having one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the gNB 900 may be configured to perform any one or more of the functions described herein. For example, the processor 904, as utilized in a gNB 900, may be configured (e.g., in coordination with the memory 905) to implement any one or more of the processes and procedures described below and illustrated in FIG. 12.

The processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a communication interface or means for communicating with various other apparatus over a transmission medium. Depending upon the nature of the apparatus, a user interface 912 (e.g., keypad, display, speaker, microphone, joystick) may also be provided. Of course, such a user interface 912 is optional, and some examples, such as a base station, may omit it.

In some aspects of the disclosure, the processor 904 may include communication control circuitry 940 configured (e.g., in coordination with the memory 905) for various functions, including, e.g., transmitting and receiving user data and control signaling messages. For example, the communication control circuitry 940 may be configured to implement one or more of the functions described below in relation to FIG. 12, including, e.g., blocks 1202, 1204, 1206, 1208, 1210, and/or 1212. The processor 904 may further include beamforming circuitry 942 configured (e.g., in coordination with the memory 905) for various functions, including, e.g., transmitting one or more CSI-RS resources over repetitive beams at different time instances (e.g., corresponding to a CSI-RS resource set configured with the parameter repetition=on). For example, the beamforming circuitry 942 may be configured to implement one or more of the functions described below in relation to FIG. 12, including, e.g., block 1210. The processor 904 may further include beam blockage prediction circuitry 944 configured (e.g., in coordination with the memory 905) for various functions, including, e.g., performing a beam blockage prediction procedure utilizing the signal quality measurement information received from a UE. For example, the beam blockage prediction circuitry 944 may be configured to implement one or more of the functions described below in relation to FIG. 12, including, e.g., block 1214.

The processor 904 is responsible for managing the bus 902 and general processing, including the execution of software stored on the computer-readable medium 906. The software, when executed by the processor 904, causes the processing system 914 to perform the various functions described below for any particular apparatus. The processor 904 may also use the computer-readable medium 906 and the memory 905 for storing data that the processor 904 manipulates when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906. The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In one or more examples, the computer-readable storage medium 906 may store computer-executable code that includes communication control instructions 960 that configure a gNB 900 for various functions, including, e.g., transmitting and receiving user data and control signaling messages. For example, the communication control instructions 960 may be configured to cause a gNB 900 to implement one or more of the functions described below in relation to FIG. 12, including, e.g., blocks 1202, 1204, 1206, 1208, 1210, and/or 1212. The computer-readable storage medium 906 may further store computer-executable code that includes beamforming instructions 962 that configure a gNB 900 for various functions, including, e.g., transmitting one or more CSI-RS resources over repetitive beams at different time instances (e.g., corresponding to a CSI-RS resource set configured with the parameter repetition=on). For example, the beamforming instructions 962 may be configured to cause a gNB 900 to implement one or more of the functions described below in relation to FIG. 12, including, e.g., block 1210. The computer-readable storage medium 906 may further store computer-executable code that includes beam blockage prediction instructions 964 that configure a gNB 900 for various functions, including, e.g., performing a beam blockage prediction procedure utilizing the signal quality measurement information received from a UE. For example, the beam blockage prediction instructions 964 may be configured to cause a gNB 900 to implement one or more of the functions described below in relation to FIG. 12, including, e.g., block 1214.

In one configuration, an apparatus 900 for wireless communication includes means for transmitting a CSI report configuration message, means for transmitting a set of TCI-state identifiers, means for receiving a set of TCI-state identifiers, means for transmitting a set of CRIs, means for selecting a set of UE spatial Rx filters from among a plurality of candidate spatial Rx filters, means for selecting one or more CSI-RS resources of a CSI-RS resource set for reporting a set of signal quality measurements, means for receiving a CSI report, means for receiving UE capability information, and means for predicting a beam blockage. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, 3, 6, 7, and/or 8, and utilizing, for example, the processes and/or algorithms described herein in relation to FIGS. 8 and/or 12.

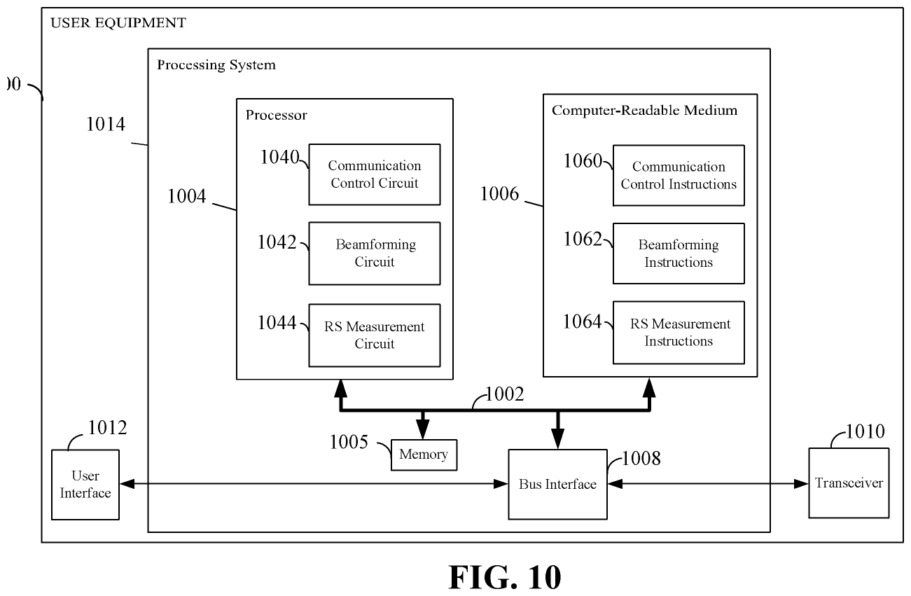

FIG. 10 is a conceptual diagram illustrating an example of a hardware implementation for an exemplary scheduled entity 1000 employing a processing system 1014. In accordance with various aspects of the disclosure, a processing system 1014 may include an element, or any portion of an element, or any combination of elements having one or more processors 1004. For example, the UE 1000 may be a UE as illustrated in any one or more of FIGS. 1, 2, 3, 5, 7, and/or 8.

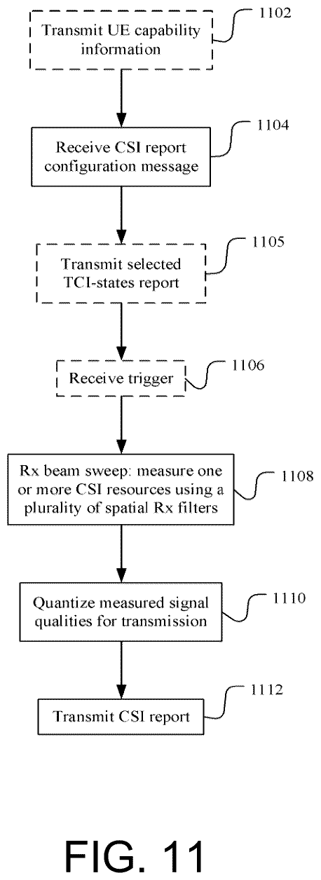

The processing system 1014 may be substantially the same as the processing system 914 illustrated in FIG. 9, including a bus interface 1008, a bus 1002, memory 1005, a processor 1004, and a computer-readable medium 1006. Furthermore, the UE 1000 may include a user interface 1012 and a transceiver 1010 substantially similar to those described above in FIG. 9. That is, the processor 1004, as utilized in a UE 1000, may be configured (e.g., in coordination with the memory 1005) to implement any one or more of the processes described below and illustrated in FIG. 11.

In some aspects of the disclosure, the processor 1004 may include communication control circuitry 1040 configured (e.g., in coordination with the memory 1005) for various functions, including, e.g., transmitting and receiving user data and control signaling messages. For example, the communication control circuitry 940 may be configured to implement one or more of the functions described below in relation to FIG. 11, including, e.g., blocks 1102, 1104, 1105, 1106, 1110, and/or 1112. The processor 1004 may further include beamforming circuitry configured (e.g., in coordination with the memory 1005) for various functions, including, e.g., receiving one or more CSI-RS resources utilizing a plurality of spatial Rx filters. In some examples, the beamforming circuit 1042 may select the set of spatial Rx filters to utilize, while in other examples, the UE 1000 may receive a gNB order indicating which spatial Rx filters to utilize. For example, the beamforming circuitry 1042 may be configured to implement one or more of the functions described below in relation to FIG. 11, including, e.g., block 1108. The processor 1004 may further include RS measurement circuitry 1044 configured (e.g., in coordination with the memory 1005) for various functions, including, e.g., measuring one or more CSI-RS resources of a CSI-RS resource set with a parameter repetition set to on. For example, the RS measurement circuit 1044 may be configured to implement one or more of the functions described below in relation to FIG. 11, including, e.g., block 1108.

And further, the computer-readable storage medium 1006 may store computer-executable code that includes communication control instructions 1060 that configure a UE 1000 for various functions, including, e.g., transmitting and receiving user data and control signaling messages. For example, the communication control instructions 1060 may be configured to cause a UE 1000 to implement one or more of the functions described below in relation to FIG. 11, including, e.g., blocks 1102, 1104, 1105, 1106, 1110, and/or 1112. The computer-readable storage medium 1006 may further store computer-executable code that includes beamforming instructions 1062 that configure a UE 1000 for various functions, including, e.g., receiving one or more CSI-RS resources utilizing a plurality of spatial Rx filters. In some examples, the beamforming instructions 1062 may select the set of spatial Rx filters to utilize, while in other examples, the UE 1000 may receive a gNB order indicating which spatial Rx filters to utilize. For example, the beamforming instructions 1062 may be configured to cause a UE 1000 to implement one or more of the functions described below in relation to FIG. 11, including, e.g., block 1108. The computer-readable storage medium 1006 may further store computer-executable code that includes RS measurement instructions 1064 that configure a UE 1000 for various functions, including, e.g., measuring one or more CSI-RS resources of a CSI-RS resource set with a parameter repetition set to on. For example, the RS measurement instructions 1064 may be configured to cause a UE 1000 to implement one or more of the functions described below in relation to FIG. 11, including, e.g., block 1108.

In one configuration, an apparatus 1000 for wireless communication includes means for receiving a CSI report configuration message, means for receiving a set of TCI-state identifiers, means for transmitting a set of TCI-state identifiers, means for receiving a set of CRIs, means for selecting a set of spatial Rx filters from among a plurality of candidate spatial Rx filters, means for measuring one or more CSI-RS resources, means for selecting one or more CSI-RS resources of a CSI-RS resource set for reporting a set of signal quality measurements, means for transmitting a CSI report, and means for transmitting UE capability information. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1, 2, 3, 6, 7, and/or 8, and utilizing, for example, the processes and/or algorithms described herein in relation to FIGS. 8 and/or 11.

FIG. 11 is a flow chart illustrating an exemplary process 1100 for a UE to report reference signal qualities with a CSI-RS resource set with the parameter repetition=on via different spatial Rx filters in accordance with some aspects of the present disclosure. As described below, a particular implementation may omit some or all illustrated features, and may not require some illustrated features to implement all embodiments. In some examples, the UE 1000 illustrated in FIG. 10 may be configured to carry out the process 1100. In some examples, any suitable apparatus or means for carrying out the functions or algorithm described below may carry out the process 1100.

At optional block 1102, the UE 1000 may transmit capability information signaling to inform the RAN about certain capabilities of the UE 1000 relating to signal quality reporting with a CSI-RS resource set having the parameter repetition=on. For example, the UE 1000 may optionally transmit UE capability information for indicating that the UE 1000 supports a feature of reporting signal quality measurement information in association with CSI-RS resources when the parameter repetition=on. Further, the UE 1000 may optionally transmit UE capability information for indicating a maximum quantity of signal qualities that the UE is capable of reporting in a CSI report.

At block 1104, the UE 1000 may receive a CSI report configuration message that configures a CSI-RS resource set with a parameter repetition set to on. That is, the gNB may configure the UE 1000 for a CSI-RS resource set that transmits a CSI-RS on repetitive beams over different time instances. In some examples, the CSI report configuration message may be carried via RRC signaling, although any suitable message format may be employed in various examples.

In some examples (e.g., when the configured CSI-RS resource set is a periodic CSI-RS resource set), the CSI report configuration message may include a set of TCI-state IDs associated with the CSI-RS resource set, for identifying a set of spatial Rx filters for the UE 1000 to employ during an Rx beam sweep. That is, the gNB may utilize the CSI report configuration message to indicate a set of spatial Rx filters for the UE 1000 to employ by transmitting to the UE 1000 a set of TCI-state IDs associated with those spatial Rx filters.

In some examples, the CSI report configuration message may further include a set of one or more CRIs as an indication of which RSRPs/SINRs the UE 1000 should report in a CSI report. That is, a gNB may indicate to the UE 1000 a set of one or more CRIs that are associated with the CSI-RS resource set, and the UE 1000 may treat these indicated CRIs as an indication of which RSRPs/SINRs the CSI report should carry.

At optional block 1105, in an example where the UE 1000 selects the set of spatial Rx filters for receiving the one or more CSI-RS resources, the UE may transmit a selected TCI-states report for reporting the plurality of spatial Rx filters. For example, the UE 1000 may utilize static (e.g., RRC) or semi-static (e.g., MAC-CE) signaling to report a selected set of TCI-states, associated with the plurality of spatial Rx filters.

At optional block 1106, the UE 1000 may receive a trigger message corresponding to the CSI-RS resource set. For example, when the configured CSI-RS resource set is an aperiodic or semi-periodic CSI-RS resource set, a measurement of the CSI-RS resource set may be triggered or activated utilizing a suitable DCI or MAC-CE, respectively. In some examples, the trigger message may include a set of TCI-state IDs associated with the CSI-RS resource set, for identifying a set of spatial Rx filters for the UE 1000 to employ during an Rx beam sweep. That is, the gNB may utilize a suitable DCI or MAC-CE to indicate a set of spatial Rx filters for the UE 1000 to employ by transmitting to the UE 1000 a set of TCI-state IDs associated with those spatial Rx filters.

In some examples where the gNB signals a set of TCI-state IDs to the UE 1000 (e.g., as part of the CSI report configuration message, DCI, MAC-CE, etc.), the UE 1000 may further utilize these TCI-state IDs to identify CSI-RS resources within the CSI-RS resource set. That is, the TCI-state IDs may be used to indicate which RSRPs/SINRs the UE 1000 is to report in a CSI report.

In some examples, the trigger message may further include a set of one or more CRIs as an indication of which RSRPs/SINRs the UE 1000 should report in a CSI report. That is, the gNB may indicate to the UE 1000 a set of one or more CRIs that are associated with a configured CSI-RS resource set, and the UE 1000 may treat these indicated CRIs as an indication of which RSRPs/SINRs the CSI report should carry.

At block 1108, the UE 1000 may perform a Rx beam sweep, measuring one or more CSI-RS resources using a plurality of spatial Rx filters. In some examples, the UE 1000 may utilize gNB-ordered spatial Rx filters for receiving the one or more CSI-RS resources. For example, as described above, the CSI report configuration message, a DCI, or a MAC-CE trigger message may indicate a set of spatial Rx filters by carrying a set of TCI-state IDs associated with the spatial Rx filters. In other examples, the UE 1000 may select the set of spatial Rx filters for receiving the one or more CSI-RS resources. Here, the UE 1000 can report the plurality of spatial Rx filters in a selected TCI-states report (block 1105 above), or in other examples, can report the plurality of spatial Rx filters in the CSI report (block 1112 below).

At block 1110, the UE 1000 may quantize the measured signal qualities for transmission. For example, the UE 1000 may identify the CRI or TCI-state ID associated with the strongest RSRP/SINR, along with the absolute value of such strongest RSRP/SINR. Further, the UE 1000 may determine differential values of other RSRPs/SINRs to be reported, referring to the strongest RSRP/SINR. These values may then be reported in ascending or descending order of the associated CRIs or TCI-state IDs.

At block 1112, the UE 1000 may transmit a CSI report according to the CSI report configuration message received at block 1104. Here, the CSI report includes signal quality measurement information based on the measurements of one or more CSI-RS resources. In some examples, e.g., where the UE 1000 selects the set of spatial Rx filters for receiving the one or more CSI-RS resources, the CSI report may include a selected TCI-states report for reporting the plurality of spatial Rx filters.

FIG. 12 is a flow chart illustrating an exemplary process 1200 for a RAN node to utilize reference signal quality reporting with a CSI-RS resource set with the parameter repetition on via different spatial Rx filters in accordance with some aspects of the present disclosure. As described below, a particular implementation may omit some or all illustrated features, and may not require some illustrated features to implement all embodiments. In some examples, the gNB 900 illustrated in FIG. 9 may be configured to carry out the process 1200. In some examples, any suitable apparatus or means for carrying out the functions or algorithm described below may carry out the process 1200.

At optional block 1202, the gNB 900 may receive capability information signaling for informing the gNB about certain capabilities of a UE 1000 relating to signal quality reporting with a CSI-RS resource set having the parameter repetition set to on. For example, the gNB 900 may optionally receive UE capability signaling indicating that a UE 1000 supports a feature of reporting signal quality measurement information in association with CSI-RS resources when the parameter repetition on. Further, the gNB 900 may optionally receive UE capability information for indicating a maximum quantity of signal qualities that the UE 1000 is capable of reporting in a CSI report.

At block 1204, the gNB 900 may transmit a CSI report configuration message that configures a CSI-RS resource set with a parameter repetition set to on. That is, the gNB 900 may configure a UE 1000 for a CSI-RS resource set that transmits a CSI-RS on repetitive beams over different time instances. In some examples, the CSI report configuration message may be carried via RRC signaling, although any suitable message format may be employed in various examples.

In some examples (e.g., when the configured CSI-RS resource set is a periodic CSI-RS resource set), the CSI report configuration message may include a set of TCI-state IDs associated with the CSI-RS resource set, for identifying a set of spatial Rx filters for the UE 1000 to employ during an Rx beam sweep. That is, the gNB 900 may utilize the CSI report configuration message to indicate a set of spatial Rx filters for the UE 1000 to employ by transmitting to the UE 1000 a set of TCI-state IDs associated with those spatial Rx filters.

In some examples, the CSI report configuration message may further include a set of one or more CRIs as an indication of which RSRPs/SINRs the UE 1000 should report in a CSI report. That is, the gNB 900 may indicate to the UE 1000 a set of one or more CRIs that are associated with the CSI-RS resource set, and the UE 1000 may treat these indicated CRIs as an indication of which RSRPs/SINRs the CSI report should carry.

At optional block 1206, in an example where the UE 1000 selects the set of spatial Rx filters for receiving the one or more CSI-RS resources, the gNB 900 may receive a selected TCI-states report for reporting the plurality of spatial Rx filters. For example, the gNB 900 may receive static (e.g., RRC) or semi-static (e.g., MAC-CE) signaling to report a selected set of TCI-states, associated with the plurality of spatial Rx filters.

At optional block 1208, the gNB 900 may transmit a trigger message corresponding to the CSI-RS resource set. For example, when the configured CSI-RS resource set is an aperiodic or semi-periodic CSI-RS resource set, the gNB 900 may trigger or activate a measurement of the CSI-RS resource set utilizing a suitable DCI or MAC-CE, respectively. In some examples, the trigger message may include a set of TCI-state IDs associated with the CSI-RS resource set, for identifying a set of spatial Rx filters for the UE 1000 to employ during an Rx beam sweep. That is, the gNB 900 may utilize a suitable DCI or MAC-CE to indicate a set of spatial Rx filters for the UE 1000 to employ by transmitting to the UE 1000 a set of TCI-state IDs associated with those spatial Rx filters.

In some examples where the gNB 900 signals a set of TCI-state IDs to the UE 1000 (e.g., as part of the CSI report configuration message, DCI, MAC-CE, etc.), the gNB may utilize the TCI-state IDs to indicate which RSRPs/SINRs the UE 1000 is to report in a CSI report.

In some examples, the trigger message may further include a set of one or more CRIs as an indication of which RSRPs/SINRs the UE 1000 should report in a CSI report. That is, the gNB 900 may indicate to the UE 1000 a set of one or more CRIs that are associated with a configured CSI-RS resource set, for indicating which RSRPs/SINRs the CSI report should carry.

At block 1210, the gNB 900 may transmit one or more CSI-RS resources with repetition set to on. That is, to facilitate an Rx beam sweep by a UE 1000, the gNB may transmit one or more CSI-RS resources on repetitive beams at different time instances.

At block 1212, the gNB 900 may receive a CSI report according to the CSI report configuration message transmitted at block 1204. Here, the CSI report includes signal quality measurement information based on the measurements of one or more CSI-RS resources. In some examples, e.g., where the UE 1000 selects the set of spatial Rx filters for receiving the one or more CSI-RS resources, the CSI report may include a selected TCI-states report for reporting the plurality of spatial Rx filters.

At block 1214, the gNB 900 may perform a beam blockage prediction procedure utilizing the signal quality measurement information included in the CSI report. For example, the gNB 900 may employ a suitable artificial intelligence (AI) or machine learning (ML) procedure to recognize a signature of an imminent beam blockage and to compensate for an anticipated beam failure.

### Further Examples Having a Variety of Features:

Example 1: A method, apparatus, and non-transitory computer-readable medium for wireless communication. A wireless user equipment (UE) comprises a memory and a processor communicatively coupled to the memory. The UE is configured to receive, via a transceiver communicatively coupled to the processor, a channel state information (CSI) report configuration message configuring a CSI reference signal (CSI-RS) resource set with a parameter repetition set to on. The UE is further configured to measure one or more CSI-RS resources of the CSI-RS resource set utilizing a plurality of spatial receiver (Rx) filters. The UE is further configured to transmit, via the transceiver, a CSI report according to the CSI report configuration message, the CSI report comprising signal quality measurement information based on the measuring of the one or more CSI-RS resources.

Example 2: The method, apparatus, and non-transitory computer-readable medium of Example 1, wherein the UE further receives, via the transceiver, a set of transmission configuration information (TCI)-state identifiers associated with the CSI-RS resource set, for identifying the plurality of spatial Rx filters.

Example 3: The method, apparatus, and non-transitory computer-readable medium of either of Examples 1 to 2, wherein the TCI-state identifiers are further for identifying the one or more CSI-RS resources of the CSI-RS resource set.

Example 4: The method, apparatus, and non-transitory computer-readable medium of Example 1, wherein the UE further selects the plurality of spatial Rx filters from among a plurality of candidate spatial Rx filters. The UE further transmits, via the transceiver, a set of transmission configuration information (TCI)-state identifiers associated with the CSI-RS resource set, for identifying the plurality of spatial Rx filters.

Example 5: The method, apparatus, and non-transitory computer-readable medium of any of Examples 1 to 4, wherein the UE further receives, via the transceiver, a set of CSI-RS resource identifiers (CRIs) associated with the CSI-RS resource set, for identifying the one or more CSI-RS resources of the CSI-RS resource set.

Example 6: The method, apparatus, and non-transitory computer-readable medium of any of Examples 1 to 4, wherein the UE is further configured to select the one or more CSI-RS resources of the CSI-RS resource set for reporting the signal quality measurement information.

Example 7: The method, apparatus, and non-transitory computer-readable medium of any of Examples 1 to 6, wherein the CSI report configuration message comprises a plurality of sub-groups of the CSI-RS resources in the CSI-RS resource set, wherein the one or more CSI-RS resources correspond to a selected sub-group of the plurality of sub-groups, and wherein the CSI report further comprises a sub-group identifier for identifying the selected sub-group.

Example 8: The method, apparatus, and non-transitory computer-readable medium of any of Examples 1 to 8, wherein the CSI report configuration message comprises a quantity of signal qualities for the UE to report in the signal quality measurement information.

Example 9: The method, apparatus, and non-transitory computer-readable medium of any of Examples 1 to 9, wherein the UE further transmits, via the transceiver, UE capability information for indicating a maximum quantity of signal qualities that the UE is capable of reporting in the signal quality measurement information.

Example 10: The method, apparatus, and non-transitory computer-readable medium of any of Examples 1 to 9, wherein the signal quality measurement information comprises at least one of a reference signal received power (RSRP) or a signal-to-interference-and-noise ratio (SINR).

Example 11: The method, apparatus, and non-transitory computer-readable medium of any of Examples 1 to 10, wherein the UE further transmits UE capability information for indicating that the UE supports reporting the signal quality measurement information in association with the one or more CSI-RS resources when the parameter repetition is set to on.

Example 12: A method, apparatus, and non-transitory computer-readable medium for wireless communication. A radio access network (RAN) node includes a memory and a processor communicatively coupled to the memory. The RAN node is configured to transmit, via a transceiver communicatively coupled to the processor, a channel state information (CSI) report configuration message configuring a CSI reference signal (CSI-RS) resource set with a parameter repetition set to on. The RAN node is further configured to transmit, via the transceiver, a set of transmission configuration information (TCI)-state identifiers associated with the CSI-RS resource set, for identifying a plurality of spatial receiver (Rx) filters for receiving one or more CSI-RS resources of the CSI-RS resource set. The RAN node is further configured to transmit, via the transceiver, the one or more CSI-RS resources of the CSI-RS resource set. The RAN node is further configured to receive, via the transceiver, a CSI report according to the CSI report configuration message, the CSI report comprising signal quality measurement information based on a measurement of the one or more CSI-RS resources.

Example 13: The method, apparatus, and non-transitory computer-readable medium of Example 12, wherein the TCI-state identifiers are further for identifying the one or more CSI-RS resources of the CSI-RS resource set.

Example 14: The method, apparatus, and non-transitory computer-readable medium of Example 12, wherein the RAN node further transmits, via the transceiver, a set of CSI-RS resource identifiers (CRIs) associated with the CSI-RS resource set, for identifying the one or more CSI-RS resources of the CSI-RS resource set.

Example 15: The method, apparatus, and non-transitory computer-readable medium of any of Examples 12 to 14, wherein the CSI report configuration message comprises a plurality of sub-groups of the CSI-RS resources in the CSI-RS resource set, wherein the one or more CSI-RS resources correspond to a selected sub-group of the plurality of sub-groups, and wherein the CSI report further comprises a sub-group identifier for identifying the selected sub-group.

Example 16: The method, apparatus, and non-transitory computer-readable medium of any of Examples 12 to 15, wherein the signal quality measurement information comprises at least one of a reference signal received power (RSRP) or a signal-to-interference-and-noise ratio (SINR).

Example 17: A method, apparatus, and non-transitory computer-readable medium for wireless communication. A radio access network (RAN) node includes a memory and a processor communicatively coupled to the memory. The RAN node is configured to transmit, via a transceiver communicatively coupled to the processor, a channel state information (CSI) report configuration message configuring a CSI reference signal (CSI-RS) resource set with a parameter repetition set to on. The RAN node is further configured to transmit, via the transceiver, one or more CSI-RS resources of the CSI-RS resource set. The RAN node is further configured to receive, via the transceiver, a CSI report according to the CSI report configuration message, the CSI report comprising signal quality measurement information based on a measurement of the one or more CSI-RS resources. The RAN node is further configured to receive, via the transceiver, a selected transmission configuration information (TCI)-states report comprising a set of TCI-state identifiers associated with the CSI-RS resource set, for identifying a plurality of spatial receiver (Rx) filters for receiving the one or more CSI-RS resources of the CSI-RS resource set.

Example 18: The method, apparatus, and non-transitory computer-readable medium of Example 17, wherein the RAN node further receives, via the transceiver, a set of CSI-RS resource identifiers (CRIs) associated with the CSI-RS resource set, for identifying the one or more CSI-RS resources of the CSI-RS resource set.

Example 19: The method, apparatus, and non-transitory computer-readable medium of either of Examples 17 or 18, wherein the CSI report configuration message comprises a plurality of sub-groups of the CSI-RS resources in the CSI-RS resource set, wherein the one or more CSI-RS resources correspond to a selected sub-group of the plurality of sub-groups, and wherein the CSI report further comprises a sub-group identifier for identifying the selected sub-group.

Example 20: The method, apparatus, and non-transitory computer-readable medium of any of Examples 17 to 19, wherein the signal quality measurement information comprises at least one of a reference signal received power (RSRP) or a signal-to-interference-and-noise ratio (SINR).

The detailed description set forth above in connection with the appended drawings is intended as a description of various configurations and is not intended to represent the only configurations in which the concepts described herein may be practiced. The detailed description includes specific details for the purpose of providing a thorough understanding of various concepts. However, those skilled in the art will readily recognize that these concepts may be practiced without these specific details. In some instances, this description provides well known structures and components in block diagram form in order to avoid obscuring such concepts.

While this description describes certain aspects and examples with reference to some illustrations, those skilled in the art will understand that additional implementations and use cases may come about in many different arrangements and scenarios. Innovations described herein may be implemented across many differing platform types, devices, systems, shapes, sizes, packaging arrangements. For example, implementations and/or uses may come about via integrated chip (IC) embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may span over a spectrum from chip-level or modular components to non-modular, non-chip-level implementations and further to aggregate, distributed, or original equipment manufacturer (OEM) devices or systems incorporating one or more aspects of the disclosed technology. In some practical settings, devices incorporating described aspects and features may also necessarily include additional components and features for implementation and practice of claimed and described embodiments. For example, transmission and reception of wireless signals includes a number of components for analog and digital purposes (e.g., hardware components including antenna, radio frequency (RF) chains, power amplifiers, modulators, buffer, processor(s), interleaver, adders/summers, etc.). It is intended that the disclosed technology may be practiced in a wide variety of devices, chip-level components, systems, distributed arrangements, end-user devices, etc. of varying sizes, shapes and constitution.

By way of example, various aspects of this disclosure may be implemented within systems defined by 3GPP, such as fifth-generation New Radio (5G NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

The present disclosure uses the word “exemplary” to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The present disclosure uses the terms “coupled” and/or “communicatively coupled” to refer to a direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The present disclosure uses the terms “circuit” and “circuitry” broadly, to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-12 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-12 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

Applicant provides this description to enable any person skilled in the art to practice the various aspects described herein. Those skilled in the art will readily recognize various modifications to these aspects, and may apply the generic principles defined herein to other aspects. Applicant does not intend the claims to be limited to the aspects shown herein, but to be accorded the full scope consistent with the language of the claims, wherein reference to an element in the singular is not intended to mean “one and only one” unless specifically so stated, but rather “one or more.” Unless specifically stated otherwise, the present disclosure uses the term “some” to refer to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) configured for wireless communication, the UE comprising:
a memory; and
a processor communicatively coupled to the memory and configured to:
receive, via a transceiver communicatively coupled to the processor, a channel state information (CSI) report configuration message configuring a CSI reference signal (CSI-RS) resource set with a parameter repetition set to on;
measure one or more CSI-RS resources of the CSI-RS resource set utilizing a plurality of spatial receiver (Rx) filters; and
transmit, via the transceiver, a CSI report according to the CSI report configuration message, the CSI report comprising signal quality measurement information based on the measuring of the one or more CSI-RS resources.

2. The UE of claim 1, wherein the processor is further configured to:
receive, via the transceiver, a set of transmission configuration information (TCI)-state identifiers associated with the CSI-RS resource set, for identifying the plurality of spatial Rx filters.

3. The UE of claim 2, wherein the TCI-state identifiers are further for identifying the one or more CSI-RS resources of the CSI-RS resource set.

4. The UE of claim 1, wherein the processor is further configured to:
select the plurality of spatial Rx filters from among a plurality of candidate spatial Rx filters; and
transmit, via the transceiver, a set of transmission configuration information (TCI)-state identifiers associated with the CSI-RS resource set, for identifying the plurality of spatial Rx filters.

5. The UE of claim 1, wherein the processor is further configured to:
receive, via the transceiver, a set of CSI-RS resource identifiers (CRIs) associated with the CSI-RS resource set, for identifying the one or more CSI-RS resources of the CSI-RS resource set.

6. The UE of claim 1, wherein the processor is further configured to:
select the one or more CSI-RS resources of the CSI-RS resource set for reporting the signal quality measurement information.

7. The UE of claim 6,
wherein the CSI report configuration message comprises a plurality of sub-groups of the CSI-RS resources in the CSI-RS resource set,
wherein the one or more CSI-RS resources correspond to a selected sub-group of the plurality of sub-groups, and
wherein the CSI report further comprises a sub-group identifier for identifying the selected sub-group.

8. The UE of claim 1,
wherein the CSI report configuration message comprises a quantity of signal qualities for the UE to report in the signal quality measurement information.

9. The UE of claim 8, wherein the processor is further configured to:
transmit, via the transceiver, UE capability information for indicating a maximum quantity of signal qualities that the UE is capable of reporting in the signal quality measurement information.

10. The UE of claim 1, wherein the signal quality measurement information comprises at least one of a reference signal received power (RSRP) or a signal-to-interference-and-noise ratio (SINR).

11. The UE of claim 1, wherein the processor is further configured to:
transmit, via the transceiver, UE capability information for indicating that the UE supports reporting the signal quality measurement information in association with the one or more CSI-RS resources when the parameter repetition is set to on.

12. A radio access network (RAN) node configured for wireless communication, the RAN node comprising:
a memory; and
a processor communicatively coupled to the memory and configured to:
transmit, via a transceiver communicatively coupled to the processor, a channel state information (CSI) report configuration message configuring a CSI reference signal (CSI-RS) resource set with a parameter repetition set to on;
transmit, via the transceiver, a set of transmission configuration information (TCI)-state identifiers associated with the CSI-RS resource set, for identifying a plurality of spatial receiver (Rx) filters for receiving one or more CSI-RS resources of the CSI-RS resource set;
transmit, via the transceiver, the one or more CSI-RS resources of the CSI-RS resource set; and
receive, via the transceiver, a CSI report according to the CSI report configuration message, the CSI report comprising signal quality measurement information based on a measurement of the one or more CSI-RS resources.

13. The RAN node of claim 12, wherein the TCI-state identifiers are further for identifying the one or more CSI-RS resources of the CSI-RS resource set.

14. The RAN node of claim 12, wherein the processor is further configured to:
transmit, via the transceiver, a set of CSI-RS resource identifiers (CRIs) associated with the CSI-RS resource set, for identifying the one or more CSI-RS resources of the CSI-RS resource set.

15. The RAN node of claim 12, wherein the CSI report configuration message comprises a plurality of sub-groups of the CSI-RS resources in the CSI-RS resource set,
wherein the one or more CSI-RS resources correspond to a selected sub-group of the plurality of sub-groups, and
wherein the CSI report further comprises a sub-group identifier for identifying the selected sub-group.

16. The RAN node of claim 12, wherein the signal quality measurement information comprises at least one of a reference signal received power (RSRP) or a signal-to-interference-and-noise ratio (SINR).

17. A radio access network (RAN) node configured for wireless communication, the RAN node comprising:
a memory; and
a processor communicatively coupled to the memory and configured to:
transmit, via a transceiver communicatively coupled to the processor, a channel state information (CSI) report configuration message configuring a CSI reference signal (CSI-RS) resource set with a parameter repetition set to on;
transmit, via the transceiver, one or more CSI-RS resources of the CSI-RS resource set;
receive, via the transceiver, a CSI report according to the CSI report configuration message, the CSI report comprising signal quality measurement information based on a measurement of the one or more CSI-RS resources; and
receive, via the transceiver, a selected transmission configuration information (TCI)-states report comprising a set of TCI-state identifiers associated with the CSI-RS resource set, for identifying a plurality of spatial receiver (Rx) filters for receiving the one or more CSI-RS resources of the CSI-RS resource set.

18. The RAN node of claim 17, wherein the processor is further configured to:
receive, via the transceiver, a set of CSI-RS resource identifiers (CRIs) associated with the CSI-RS resource set, for identifying the one or more CSI-RS resources of the CSI-RS resource set.

19. The RAN node of claim 17, wherein the CSI report configuration message comprises a plurality of sub-groups of the CSI-RS resources in the CSI-RS resource set,
wherein the one or more CSI-RS resources correspond to a selected sub-group of the plurality of sub-groups, and
wherein the CSI report further comprises a sub-group identifier for identifying the selected sub-group.

20. The RAN node of claim 17, wherein the signal quality measurement information comprises at least one of a reference signal received power (RSRP) or a signal-to-interference-and-noise ratio (SINR).

21. A method of wireless communication operable at a user equipment (UE), the method comprising:
receiving a channel state information (CSI) report configuration message configuring a CSI reference signal (CSI-RS) resource set with a parameter repetition set to on;
measuring one or more CSI-RS resources of the CSI-RS resource set utilizing a plurality of spatial receiver (Rx) filters, the plurality of spatial Rx filters being either ordered by a radio access network (RAN) or reported by the UE; and
transmitting a CSI report according to the CSI report configuration message, the CSI report comprising signal quality measurement information based on the measuring of the one or more CSI-RS resources.

22. The method of claim 21, further comprising:
receiving a set of transmission configuration information (TCI)-state identifiers associated with the CSI-RS resource set, for identifying the plurality of spatial Rx filters.

23. The method of claim 22, wherein the TCI-state identifiers are further for identifying the one or more CSI-RS resources of the CSI-RS resource set.

24. The method of claim 21, further comprising:
selecting the plurality of spatial Rx filters from among a plurality of candidate spatial Rx filters; and
transmitting a set of transmission configuration information (TCI)-state identifiers associated with the CSI-RS resource set, for identifying the plurality of spatial Rx filters.

25. The method of claim 21, further comprising:
receiving a set of CSI-RS resource identifiers (CRIs) associated with the CSI-RS resource set, for identifying the one or more CSI-RS resources of the CSI-RS resource set.

26. The method of claim 21, further comprising:
selecting the one or more CSI-RS resources of the CSI-RS resource set for reporting the signal quality measurement information.

27. The method of claim 26,
wherein the CSI report configuration message comprises a plurality of sub-groups of the CSI-RS resources in the CSI-RS resource set,
wherein the one or more CSI-RS resources correspond to a selected sub-group of the plurality of sub-groups, and
wherein the CSI report further comprises a sub-group identifier for identifying the selected sub-group.

28. The method of claim 21,
wherein the CSI report configuration message comprises a quantity of signal qualities for the UE to report in the signal quality measurement information.

29. The method of claim 28, further comprising:
transmitting UE capability information for indicating a maximum quantity of signal qualities that the UE is capable of reporting in the signal quality measurement information.

30. The method of claim 21, wherein the signal quality measurement information comprises at least one of a reference signal received power (RSRP) or a signal-to-interference-and-noise ratio (SINR).
